(19) United States
(12) Patent Application Publication
(10) Pub. No.: US 2014/0079289 A1
(43) Pub. Date: Mar. 20, 2014

(54) INFORMATION GENERATION APPARATUS THAT GENERATES INFORMATION ON A SEQUENCE OF MOTIONS

(71) Applicant: CASIO COMPUTER CO., LTD., Tokyo (JP)

(72) Inventors: Futoshi YAMAMOTO, Tokyo (JP); Osamu NOJIMA, Tokyo (JP)

(73) Assignee: CASIO COMPUTER CO., LTD., Tokyo (JP)

(21) Appl. No.: 14/028,182

(22) Filed: Sep. 16, 2013

(30) Foreign Application Priority Data
Sep. 20, 2012 (JP) 2012-207343

(51) Int. Cl. G06T 7/20

(52) U.S. Cl. CPC G06T 7/20
USPC 382/107

(57) ABSTRACT

An information generation apparatus includes a specification unit that specifies a plurality of points in time of a sequence of motions of a person; and a generation unit that generates information relating to a rhythm of the sequence of motions, based on the plurality of points in time specified.

This application is based on and claims the benefit of priority from Japanese Patent Application No. 2012-207343, filed on 20 Sep. 2012, the content of which is incorporated herein by reference.

### BACKGROUND OF THE INVENTION

1. Field of the Invention

The present invention relates to an information generation apparatus that generates information on a sequence of motions, an information generation method, and a storage medium.

2. Related Art

Conventionally, in Japanese Unexamined Patent Application, Publication No. 2010-127639, a technology has been known which creates a graph showing the change of speed relating to a sequence of motions, based on data of a moving image in which a subject performing the sequence of motions is photographed.

### SUMMARY OF THE INVENTION

An information generation apparatus according to an aspect of the present invention includes:

a specification unit that specifies a plurality of points in time of a sequence of motions of a person; and

a generation unit that generates information relating to a rhythm of the sequence of motions, based on the plurality of points in time specified.

Furthermore, an information generation method according to an aspect of the present invention is

an information generation method executed by an information generation apparatus including:

a specification step of specifying a plurality of points in time of a sequence of motions of a person; and

a generation step of generating information relating to a rhythm of the sequence of motions, based on the plurality of points in time specified.

Furthermore, a storage medium according to an aspect of the present invention is

a storage medium encoded with a computer-readable program that enables a computer to execute functions as:

a specification unit that specifies a plurality of points in time of a sequence of motions of a person; and

a generation unit that generates information relating to a rhythm of the sequence of motions, based on the plurality of points in time specified.

### BRIEF DESCRIPTION OF THE DRAWINGS

FIG. 1 is a block diagram showing a hardware configuration of an information generation apparatus 1 according to a first embodiment of the present invention;

FIG. 2 is a functional block diagram showing a functional configuration for executing information notification processing, among functional configurations of the information generation apparatus 1 of FIG. 1;

FIG. 3 is a graph that visualizes swing analysis data of a professional golfer;

FIG. 4 is a graph that visualizes swing analysis data of a player;

FIG. 5 is a flowchart showing an example of a flow of rhythm information processing executed by the information generation apparatus 1 of FIG. 1 having the functional configuration of FIG. 2;

FIG. 6 is a flowchart showing an example of a flow of swing analysis processing executed by the information generation apparatus 1 of FIG. 1 having the functional configuration of FIG. 2;

FIG. 7 is a flowchart showing an example of a flow of rhythm information generation processing executed by the information generation apparatus 1 of FIG. 1 having the functional configuration of FIG. 2;

FIG. 8 is a flowchart showing an example of a flow of moving image replay processing executed by the information generation apparatus 1 of FIG. 1 having the functional configuration of FIG. 2;

FIG. 9 is a functional block diagram showing a functional configuration for executing rhythm evaluation result notification processing according to a second embodiment of the present invention, among the functional configurations of the information generation apparatus 1 shown in FIG. 1;

FIG. 10 is a flowchart showing an example of a flow of rhythm evaluation result notification processing executed by the information generation apparatus 1 of FIG. 1 having the functional configuration of FIG. 9;

FIG. 11 is a flowchart showing an example of a flow of swing analysis processing executed by the information generation apparatus 1 of FIG. 1 having the functional configuration of FIG. 9;

FIG. 12 is a flowchart showing an example of a flow of rhythm analysis processing executed by the information generation apparatus 1 of FIG. 1 having the functional configuration of FIG. 9;

FIG. 13 is a flowchart showing an example of a flow of notification processing executed by the information generation apparatus 1 of FIG. 1 having the functional configuration of FIG. 9;

FIG. 14 is a diagram showing a table in which evaluation information is stored;

FIG. 15 is a diagram showing an example of a notification image in a second embodiment;

FIG. 16 is a diagram showing an example of a notification image in a second embodiment; and

FIG. 17 is a diagram showing an example of a notification image in a second embodiment.

### DETAILED DESCRIPTION OF THE INVENTION

In the following, embodiments of the present invention are explained with reference to the drawings.

### First Embodiment

### Configuration

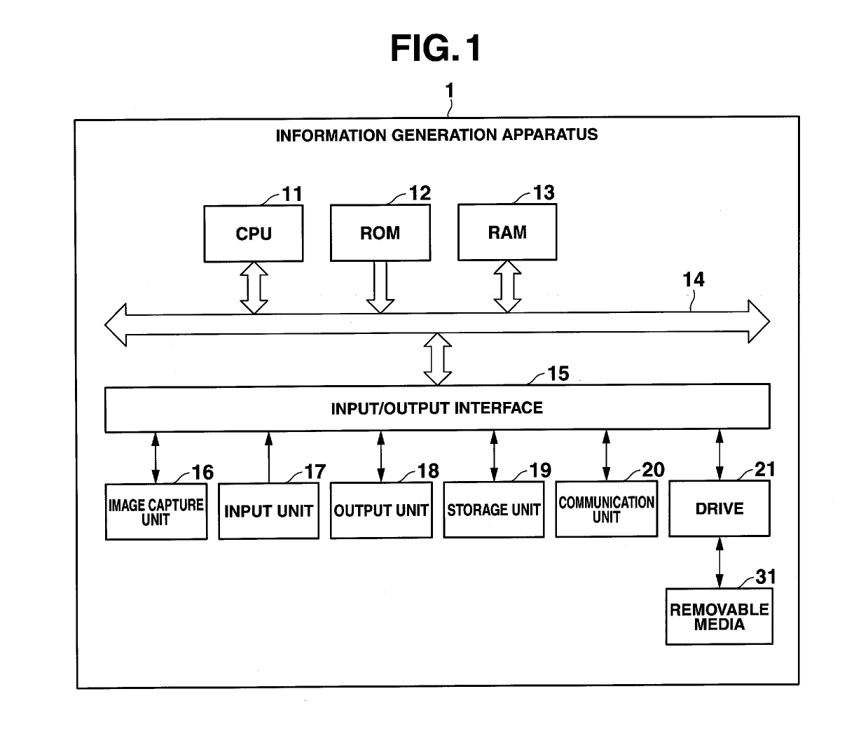

FIG. 1 is a block diagram showing a hardware configuration of an information generation apparatus according to a first embodiment of the present invention.

The information generation apparatus 1 is configured as, for example, a digital camera.

The information generation apparatus 1 includes a CPU (Central Processing Unit) 11, ROM (Read Only Memory) 12, RAM (Random Access Memory) 13, bus 14, an Input/Output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor (not illustrated).

In order to photograph a subject (a measurement subject), the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The image capture unit 16 also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “image data”. The image data is supplied to the CPU 11, RAM 13, etc. as appropriate.

Here, in the present embodiment, data of a single image is sequentially outputted every 1/30 seconds, for example, to constitute data of a moving image. In other words, in the following, an image refers to a unit image (a frame image, a field image, etc.) constituting a moving image.

The input unit 17 is configured by various buttons and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

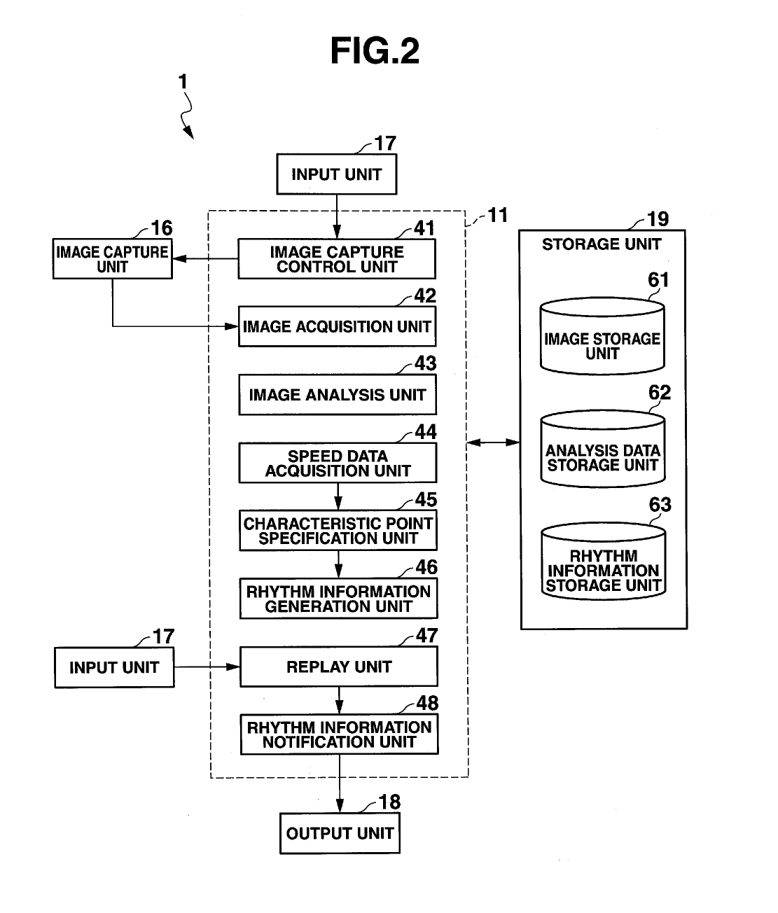

FIG. 2 is a functional block diagram showing a functional configuration for executing information notification processing, among functional configurations of the information generation apparatus 1.

The information notification processing refers to a sequence of processing of: specifying a characteristic point at each point in time of a sequence of motions based on analysis result information of a sequence of motions of a subject included in a moving image (a plurality of images) captured; associating the characteristic point with rhythm information; and outputting the rhythm information to be synchronized with the characteristic point when replaying the moving image.

In the preset embodiment, examples are explained of specifying a characteristic point of a sequence of motions based on information of an analysis result of a golf swing of a player (hereinafter, referred to as “player analysis result”) included in a moving image captured by the information generation apparatus 1, and an example of specifying a characteristic point of a sequence of motions based on information of an analysis result of a golf swing of a professional golfer (hereinafter, referred to as “professional golfer analysis result”) set in advance. However, it is also possible to specify a characteristic point of a sequence of motions based on analysis result information of a golf swing of a player included in a moving image captured previously by the information generation apparatus 1.

When the information notification processing is executed, as shown in FIG. 2, an image capture control unit 41, an image acquiring unit 42, an image analysis unit 43, a speed data acquiring unit 44, a characteristic point specification unit 45, a rhythm information generation unit 46, a replay unit 47, and a rhythm information notification unit 48 function in the CPU 11.

However, FIG. 2 is merely an example, and at least a part of the functions of the CPU 11 may be imparted to hardware that performs image processing such as a GA (Graphics Accelerator).

When the notification processing is executed, an image storage unit 61, an analysis data storage unit 62, and an information storage unit 63 that are provided as one area of the storage unit 19 are used.

In the image storage unit 61, a moving image (a plurality of images) that is outputted from the image capture unit 16 and acquired by the image acquiring unit 42 is stored.

In the analysis data storage unit 62, data of an analysis result of a player outputted from the image analysis unit 43 (described later) is stored. Furthermore, in the analysis data storage unit 62, data of an analysis result of a professional golfer set in advance (described later) is stored.

Swing analysis data of the player and swing analysis data of the professional golfer (described later), which are outputted from the rhythm information generation unit 46 and in which each characteristic point (described later) is associated with sound data (described later), are stored in the rhythm information storage unit 63.

The image capture control unit 41 sets various image capture conditions inputted via the input unit 17 and controls the operation of image capture at the image capture unit 16.

In the present embodiment, in order to capture a subject (player) who makes a sequence of motions, the image capture control unit 41 causes the image capture unit 16 to capture the subject continuously and outputs as data of a moving image.

The image acquiring unit 42 acquires data of a moving image outputted from the image capture unit 16. Then, the image acquiring unit 42 encodes data of a moving image and stores in the image storage unit 61.

The image analysis unit 43 analyzes an image based on data of a moving image stored in the image storage unit 61. In other words, the image analysis unit 43 sequentially decodes data of a moving image stored in the image storage unit 61 and stores data of a sequence of images thus decoded in the RAM 13 to analyze the sequence of images.

More specifically, the image analysis unit 43 extracts a group of image data representing a motion from the start to the end of a golf swing from among data of a sequence of images stored in the RAM 13. This is because there is generally a possibility that data unnecessary for analysis is included such as a motion before the start of a golf swing and a motion after the end of the golf swing in a group of data of the sequence of images in which a motion of a golf swing is recorded.

Next, the image analysis unit 43 specifies a location of an image of a head of a golf club (hereinafter, referred to as “head image”) for each image data of a group of image data extracted as coordinate data and stores it in the RAM 13. Furthermore, the image analysis unit 43 associates times (hereinafter, referred to as “capturing time”) at which each image data of a group of image data extracted was captured with coordinate data of the head image and stores it in the RAM 13. Next, the image analysis unit 43 calculates the moving speed of the head image based on the capturing times and the coordinate data sets of the head images stored in the RAM 13 for each of the capturing times and associates every one of the capturing times with the respective moving speeds of the head images, and stores it in the RAM 13.

Furthermore, the image analysis unit 43 stores data in which the capturing times are associated with the respective moving speeds of the head images (hereinafter, referred to as “swing analysis data”) in the analysis data storage 62.

In this way, swing analysis data as data from an analysis result of the player (hereinafter, referred to as “swing analysis data of a player”) is stored in the analysis data storage unit 62.

It should be noted that swing analysis data as data from an analysis result of the professional golfer (hereinafter, referred to as “swing analysis data of a professional golfer”) is stored in the analysis data storage unit 62 set in advance, as described above.

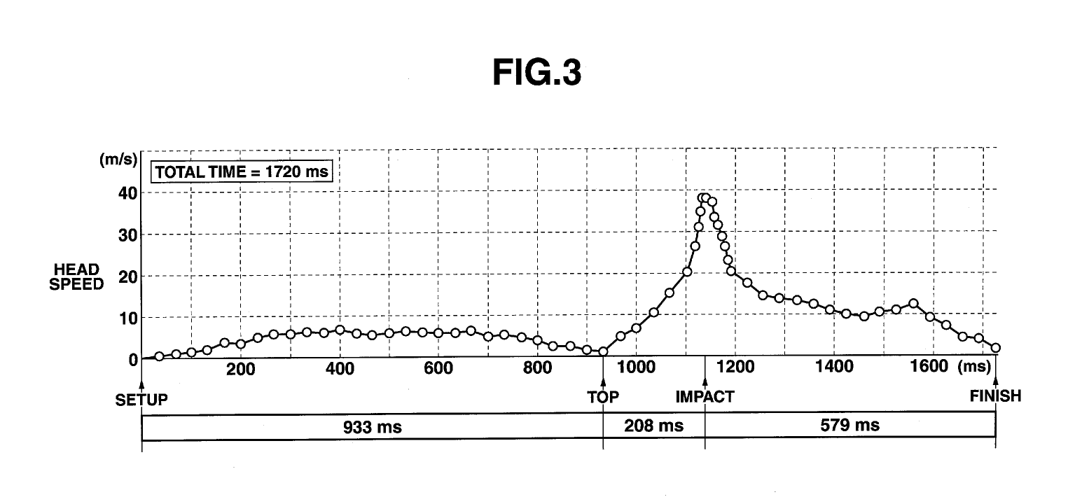

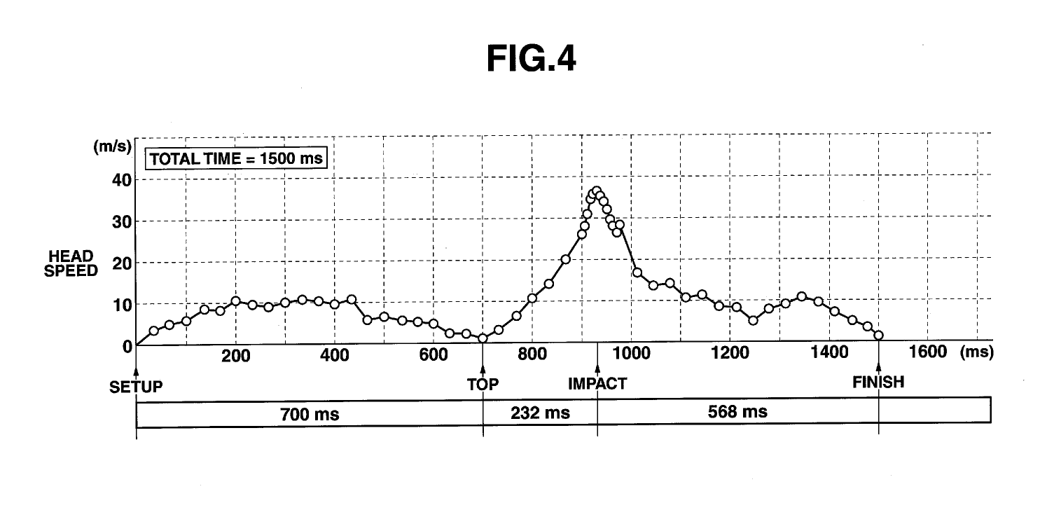

Furthermore, when the swing analysis data is visualized, a graph is drawn representing a corresponding relationship between the capturing time and the moving speed of the head images, as shown in FIGS. 3 and 4. FIG. 3 is a graph visualizing swing analysis data of a professional golfer. FIG. 4 is a graph visualizing swing analysis data of a player.

The speed data acquisition unit 44 reads the swing analysis data of the player and the swing analysis data of the professional golfer stored in the analysis data storage unit 62 by the image analysis unit 43 and stores it in the RAM 13.

The characteristic point specification unit 45 specifies four types of characteristic points based on the swing analysis data of the player and the swing analysis data of the professional golfer stored in the RAM 13 by the speed data acquisition unit 44, respectively. The four types of characteristic points include: a setup point in time; a top point in time; an impact point in time; and a finish point in time. Here, setup refers to the time of starting swinging a golf club. Top refers to the time from swinging back the golf club from setup to holding the golf club for a moment. Impact refers to the time from swinging the golf club down from top to hitting a golf ball. In the present embodiment, the speed of the head of the golf club reaches the maximum at the time of impact. Finish refers to the time from hitting the golf ball to stopping swinging the head of the golf club.

As shown in FIGS. 3 and 4, the setup point in time refers to a point in time of a first capturing time (hereinafter, referred to as “first capturing time with speed zero”) among the times at which the moving speed of the head image is zero (hereinafter, referred to as “capturing time with speed zero”). Furthermore, the top point in time refers to the point in time of a second capturing time (hereinafter, referred to as “second capturing time with speed zero”) among the times at which the moving speed of the head image is zero. Furthermore, the impact point in time refers to a point in time of a capturing time at which the moving speed of the head image reaches the maximum (hereinafter, referred to as “capturing time with maximum speed”) in the present embodiment. Furthermore, the finish point in time refers to a point in time of a third capturing time (hereinafter, referred to as “third capturing time with speed zero”) among the times at which the moving speed of the head image is zero.

It should be noted that the description of speed zero herein should not mean that the speed is exactly zero but can include moving speeds that can be recognized as being zero under predetermined criteria for judgment.

The characteristic point specification unit 45 specifies the four characteristic points based on each of the capturing times at which the speed becomes zero and the maximum speed, for the swing analysis data of the player and the swing analysis data of the professional golf player stored in the RAM 13, respectively.

More specifically, the characteristic point specification unit 45 specifies a point in time of a first capturing time with speed zero as the setup point in time. Furthermore, the characteristic point specification unit 45 specifies a point in time of a second capturing time with speed zero as the top point in time. Furthermore, the characteristic point specification unit 45 specifies a point in time of a capturing time with maximum speed as the impact point in time. Moreover, the characteristic point specification unit 45 specifies a point in time of a third capturing time with speed zero as the finish point in time.

Here, although each characteristic point is specified based on the trends of the swing analysis data calculated as in FIGS. 3 and 4, as a method for specifying a characteristic point, the present invention is not limited thereto.

For example, each characteristic point in a swing motion of the professional golfer or the player may be specified by analyzing a speed of a golf club by way of attaching a sensor unit (not shown) that can detect the acceleration/angular acceleration on a golf club of the professional golfer or the player.

The rhythm information generation unit 46 associates each characteristic point specified by the characteristic point specification unit 45 with sound data as rhythm information. For example, the rhythm information generation unit 46 associates each characteristic point corresponding to the player with a first tone and associates each characteristic point corresponding to the professional golfer with a second tone that is different from the first tone. In such a case, the pitch of a sound (hereinafter, referred to as “pitch”) may differ depending on each characteristic point. For example, it can be configured such that a pitch at the setup point in time is the lowest, a pitch at the top point in time is the second lowest, a pitch at the impact point in time is the third lowest, and a pitch at the finish point in time is the highest.

Furthermore, the rhythm information generation unit 46 stores, in the rhythm information storage unit 63, swing analysis data of the player and swing analysis data of the professional golfer in which each characteristic point is associated with sound data.

The replay unit 47 replays a moving image of the player and/or a moving image of the professional golfer corresponding to a user's instructional operation received from the input unit 17. Here, data of a moving image of the player and data of a moving image of the professional golfer are stored in the image storage unit 61.

The replay unit 47 reads and replays data of a moving image corresponding to a signal of the user's instructional operation from the image storage unit 61. Furthermore, the replay unit 47 reads swing analysis data corresponding to a type of a moving image replayed from the rhythm information storage unit 63.

The rhythm information notification unit 48 outputs sound data as rhythm information to the output unit 18 based on data of a moving image replayed by the replay unit 47 and swing analysis data read from the rhythm information storage unit 63. More specifically, the rhythm information notification unit 48 outputs sound data to the output unit 18 with the timing at which each characteristic point is displayed on a moving image by synchronizing a replay timing of a moving image thus replayed with swing analysis data thus read.

In this way, if the moving image replayed is only the moving image of the player, since a sound is outputted with the first tone by synchronizing with each characteristic point, it is possible to recognize a characteristic of a swing of the player based on sound.

Furthermore, if the moving image replayed is only the moving image of the professional golfer, since a sound is outputted with the second tone by synchronizing with each characteristic point, it is possible to recognize a characteristic of a swing of the professional golfer based on sound.

Furthermore, if the moving image replayed is both moving images of the player and the professional golfer, since sounds are outputted with the first and second tone by synchronizing with each characteristic point, it is possible to recognize a difference in swings between the player and the professional golfer based on sound.

### Information Notification Processing

Next, information notification processing executed by the information generation apparatus 1 is described.

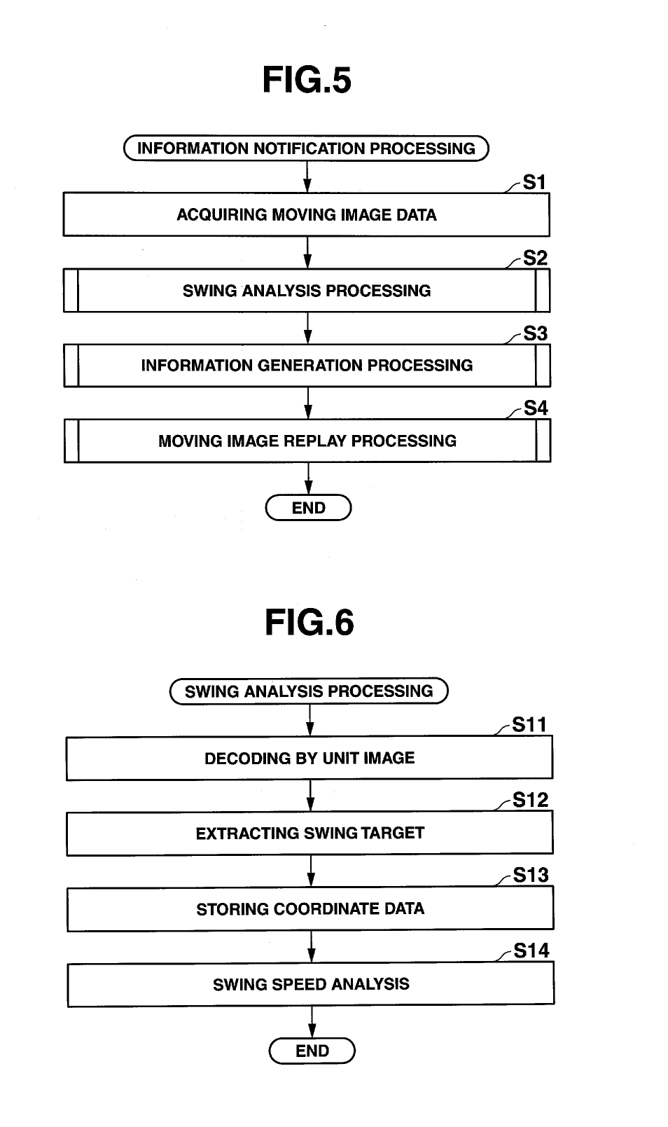

FIG. 5 is a flowchart showing an example of a flow of information notification processing (main flow) executed by the information generation apparatus 1 of FIG. 1 having the functional configuration of FIG. 2.

In FIG. 5, when data of a moving image of a subject (player) photographed continuously by the image capture unit 16 is outputted, the following processing of Steps S1 to S4 is executed.

In Step S1, the image acquisition unit 42 acquires data of a moving image outputted from the image capture unit 16. Then, the image acquisition unit 42 encodes the data of a moving image to store it in the image storage unit 61.

Then, in Step S2, the image analysis unit 43 extracts a group of image data representing a motion of a swing of a golf club at the time from the start to the end based on the data of a moving image acquired in the processing of Step S1, and creates swing analysis data that is data in which the moving speed of a head image is associated with a capturing time. In the following, such processing in Step S2 by the image analysis unit 43 is referred to as “swing analysis processing” as in the description of FIG. 5. The details of the swing analysis processing are described later with reference to FIG. 6.

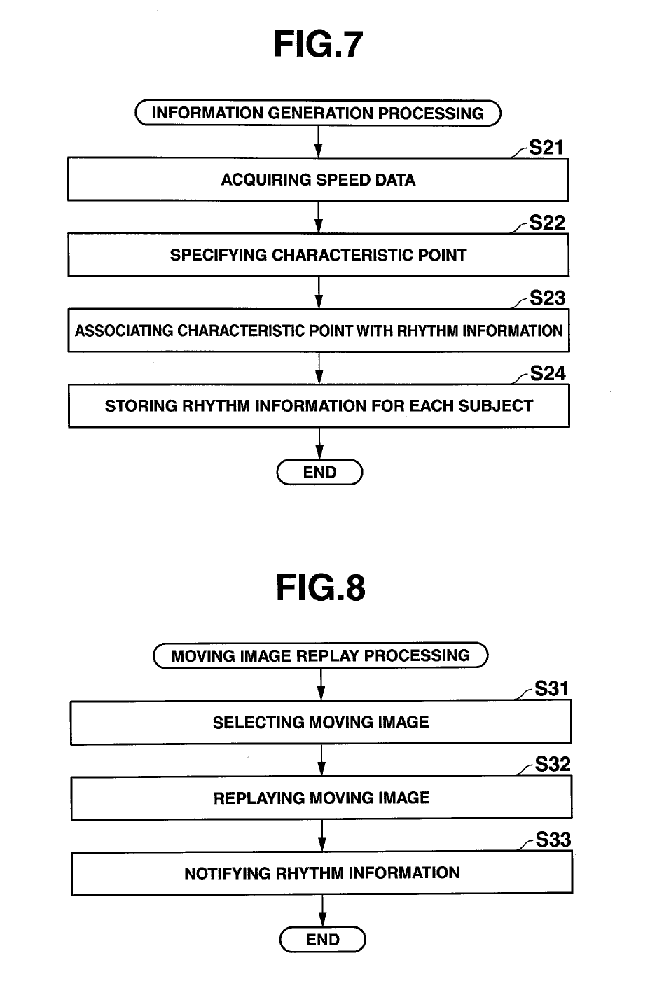

Next, in Step S3, the speed data acquisition unit 44 and the like specify each characteristic point based on the swing analysis data of a professional golfer and a player generated in the processing of Step S2 and associate sound data at a characteristic point specified with the swing analysis data of the professional golfer and the player. Such processing by the speed data acquisition unit 44 and the like of Step S3 is called “information generation processing” in accordance with FIG. 5. The details of the information generation processing are described later with reference to FIG. 7.

Next, in Step S4, the replay unit 47 and the like replay a moving image of a golf swing of the professional golfer and/or the player and outputs, to the output unit 18, sound data based on the swing analysis data of the professional golfer and/or the player to which the sound data is associated in the processing of Step S3. Such processing of the replay unit 47 and the like of Step S4 is called “moving image replay processing” in accordance with FIG. 5. The details of moving image replay processing are described later with reference to FIG. 8.

When the processing of Step S4 ends, the information notification processing ends.

### Swing Analysis Processing

Next, swing analysis processing executed by the information generation apparatus 1 is described.

FIG. 6 is a flowchart showing an example of a flow of swing analysis processing (the processing of Step S2 in FIG. 5) executed by the information generation apparatus 1 of FIG. 1 having the functional configuration of FIG. 2.

In Step S11, the image analysis unit 43 sequentially decodes data of a moving image stored in the image storage unit 61 with each image data captured as a unit and stores a group of data of a sequence of images thus decoded in the RAM 13.

Next, in Step S12, the image analysis unit 43 extracts a group of image data of a motion from the start to the end of a golf swing from among a group of data of a sequence of images stored in the RAM 13.

Next, in Step S13, the image analysis unit 43 stores a location of a head image for each image data of a group of image data extracted as coordinate data in the RAM 13. Furthermore, the image analysis unit 43 associates times at which each image data of a group of images thus extracted was captured with the coordinate data of the head image and stores it in the RAM 13.

Next, in Step S14, the image analysis unit 43 calculates the moving speed of the head image based on each of the capturing times and the coordinate data sets of each head image stored in the RAM 13 for each of the capturing times and storing in the RAM 13 by associating every one of the capturing times with the respective moving speeds of the head images.

Furthermore, the image analysis unit 43 stores swing analysis data that is data in which the capturing times are associated with the respective moving speeds of each head image in the analysis data storage 62.

When the processing of Step S14 ends, the swing analysis processing ends.

### Information Generation Processing

Next, information generation processing executed by the information generation apparatus 1 is described.

FIG. 7 is a flowchart showing an example of a flow of information generation processing (the processing of Step S3 in FIG. 5) executed by the information generation apparatus 1 of FIG. 1 having the functional configuration of FIG. 2.

In Step S21, the speed data acquisition unit 44 stores in the RAM 13 by reading swing analysis data of a player and swing analysis data of a professional golfer stored in the analysis data storage unit 62.

Next, in Step S22, the characteristic point specification unit 45 specifies the four characteristic points based on the capturing time with speed zero and the capturing time with maximum speed for each of the swing analysis data of the player and the swing analysis data of the professional golfer stored in the RAM 13 in Step S21. These four characteristic points are the setup point in time, the top point in time, the impact point in time, and the finish point in time.

Next, in Step S23, the rhythm information generation unit 46 associates each characteristic point specified in Step S22 with sound data. For example, the rhythm information generation unit 46 associates each characteristic point corresponding to the player with a first tone and associates each characteristic point corresponding to the professional golfer with a second tone that is different from the first tone.

Next, in Step S24, the rhythm information generation unit 46 stores, in the rhythm information storage unit 63, the swing analysis data of the player and the swing analysis data of the professional golfer in which each characteristic point is associated with sound data in Step S23.

When the processing of Step S24 ends, the information generation processing ends.

### Moving Image Replay Processing

Next, moving image replay processing executed by the information generation apparatus 1 is described.

FIG. 8 is a flowchart showing an example of a flow of moving image replay processing (the processing of Step S4 in FIG. 5) executed by the information generation apparatus 1 of FIG. 1 having the functional configuration of FIG. 2.

In Step S31, the replay unit 47 receives a signal for replaying only a moving image of a player, a signal for replaying only a moving image of a professional golfer, and a signal that indicates whether to replay both moving images of the player and the professional golfer, in response to a user's choice via the input unit 17.

In Step S32, the replay unit 47 reads and replays data of a moving image from the image storage unit 61 based on a signal received in Step S31. Furthermore, the replay unit 47 reads swing analysis data corresponding to a type of moving image replayed from the rhythm information storage unit 63.

In Step S33, the rhythm information notification unit 48 outputs, to the output unit 18, sound data as rhythm information based on the data of a moving image replayed by the replay unit 47 in Step S32 and the swing analysis data read from the rhythm information storage unit 63 in Step S32. More specifically, the rhythm information notification unit 48 outputs the sound data to the output unit 18 with the timing at which each characteristic point is displayed on the moving image by synchronizing a replay timing of the moving image thus replayed with the swing analysis data thus read.

When the processing of Step S33 ends, the moving image generation processing ends.

The first embodiment of the present invention is described above.

The information generation apparatus 1 executing such rhythm information processing as described above includes the characteristic point specification unit 45 and the rhythm information generation unit 46.

The characteristic point specification unit 45 specifies a predetermined point in time of a motion in a sequence of motions of a subject.

The rhythm information generation unit 46 generates sound data relating to the sequence of motions based on the predetermined point in time of a motion specified by the characteristic point specification unit 45.

Therefore, such an information generation apparatus 1 can generate sound data relating to a sequence of motions, based on the predetermined point in time of a motion by efficiently employing data of a sequence of motions of a subject.

The characteristic point specification unit 45 specifies a plurality of the predetermined points in time of motions (the setup point in time, the top point in time, the impact point in time, and the finish point in time).

Then, the rhythm information generation unit 46 generates sound data of the sequence of motions of a golf swing as information relating to the sequence of motions of the golf swing, based on the plurality of predetermined points in time of the motion specified by the characteristic point specification unit 45.

Therefore, such an information generation apparatus 1 can generate sound data based on the plurality of predetermined points in time of motions by efficiently employing swing analysis data relating to a sequence of motions of a golf swing of a subject.

The information generation apparatus 1 further includes the replay unit 47 and the rhythm information notification unit 48.

The replay unit 47 and the rhythm information notification unit 48 synchronizes, with rhythm information generated by the rhythm information generation unit 46, and plays a plurality of images in which a sequence of motions of a subject is captured.

Therefore, since it is possible to output sounds by synchronizing with the plurality of predetermined points in time of motions when a plurality of images in which a sequence of motions of a golf swing of a subject is captured is replayed, it is possible to intuitively understand a characteristic of a sequence of motions of a golf swing of a subject based on sound.

The information generation apparatus 1 further includes the image acquisition unit 42.

The image acquisition unit 42 acquires a plurality of images in which a sequence of motions of a subject is captured.

The characteristic point specification unit 45 specifies a predetermined point in time of the sequence of a motion among the plurality of images acquired by the image acquisition unit 42.

Therefore, it is possible to efficiently employ data of a sequence of motions of a subject.

### Second Embodiment

Next, a second embodiment of the present invention is described.

In the descriptions of the second embodiment below, present embodiment refers to the second embodiment.

An information generation apparatus 1 according to the second embodiment of the present invention includes a hardware configuration similar to that in the first embodiment. In other words, FIG. 1 also shows a hardware configuration of the information generation apparatus 1 according to the second embodiment. It should be noted that, since the hardware configuration of FIG. 1 is already described, explanations for the hardware configuration are omitted.

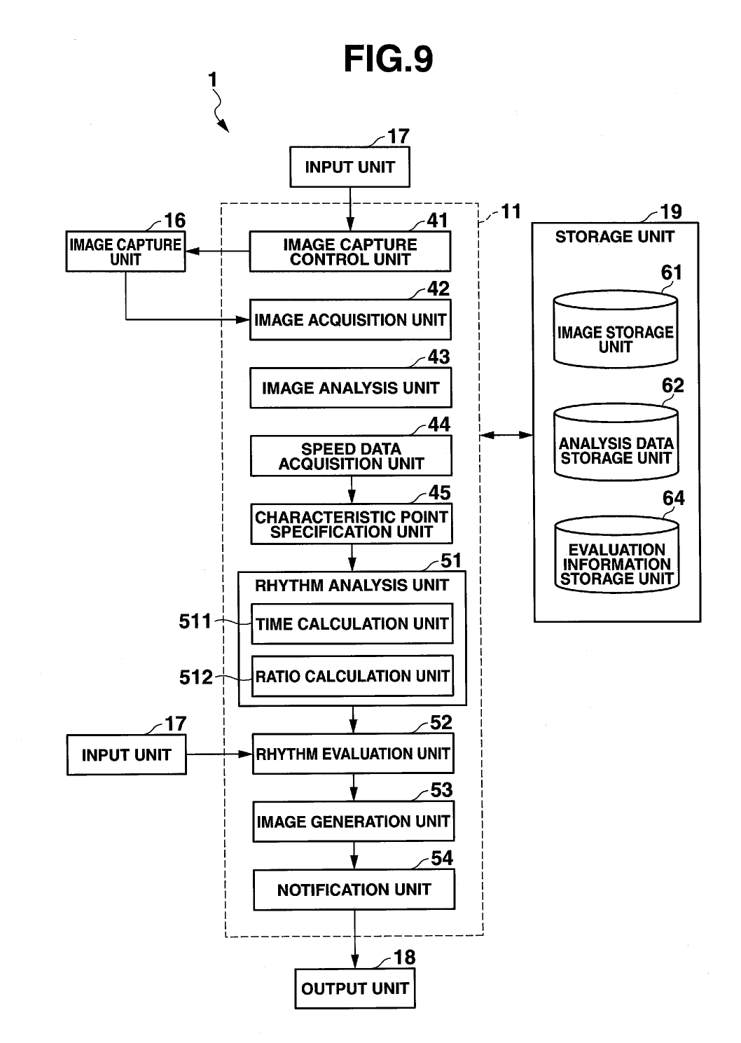

FIG. 9 is a functional block diagram showing a functional configuration for executing evaluation result notification processing among the functional configurations of the information generation apparatus 1 shown in FIG. 1.

The evaluation result notification processing refers to a sequence of processing for determining whether a player's golf swing is good or bad and notifying a determination result based on information of an analysis result of a motion of a subject included in a moving image (a plurality of images) captured.

In the present embodiment, information of an analysis result of a player's golf swing included in a moving image captured by the information generation apparatus 1 (hereinafter, referred to as “analysis result of a player”) is described. However, these descriptions can also be applied to information of an analysis result of the player's golf swing included in a moving image captured previously by the information generation apparatus 1.

When the rhythm evaluation result notification processing is executed, as shown in FIG. 9, an image capture control unit 41, an image acquisition unit 42, an image analysis unit 43, a speed data acquisition unit 44, a characteristic point specification unit 45, a rhythm analysis unit 51, an elapsed time calculation unit 511, a ratio calculation unit 512, a rhythm evaluation unit 52, an image generation unit 53, and a notification unit 54 function in the CPU 11. Here, the image capture control unit 41, the image acquisition unit 42, the image analysis unit 43, the speed data acquisition unit 44, and the characteristic point specification unit 45 are the same as those in the first embodiment.

However, FIG. 9 is merely an example, and at least a part of the functions of the CPU 11 may be imparted to hardware that performs image processing such as a GA (Graphics Accelerator).

When the rhythm evaluation result notification processing is executed, an image storage unit 61, an analysis data storage unit 62, and an evaluation information storage unit 64 that are provided as one area of the storage unit 19 are used. Here, the image storage unit 61 and the analysis data storage unit 62 are the same as those in the first embodiment.

In the evaluation information storage unit 64, a plurality of kinds of evaluation information for determining whether a player's golf swing is an ideal one (described later) is stored.

Since the image capture control unit 41, the image acquisition unit 42, the image analysis unit 43, the speed data acquisition unit 44, and the characteristic point specification unit 45 are the same as those in the first embodiment, explanations thereof are omitted. In the following, the rhythm analysis unit 51, the elapsed time calculation unit 511, the ratio calculation unit 512, the rhythm evaluation unit 52, the image generation unit 53, and the notification unit 54 are described.

The rhythm analysis unit 51 includes a time calculation unit 511 and a ratio calculation unit 512.

The time calculation unit 511 calculates a time between each characteristic point specified by the characteristic point specification unit 45. More specifically, the time calculation unit 511 calculates a time between the setup point in time and the top point in time (hereinafter, referred to as “first time”) by dividing the number of frames of images captured between the setup point in time and the top point in time by the frame rate. The same applies to an elapsed time between the setup point in time and the impact point in time (hereinafter, referred to as “second time”) as well.

The ratio calculation unit 512 calculates a ratio of the first time and the second time. In other words, the ratio is calculated by dividing the first time by the second time.

The rhythm evaluation unit 52 evaluates the ratio calculated by the ratio calculation unit 512 based on evaluation information.

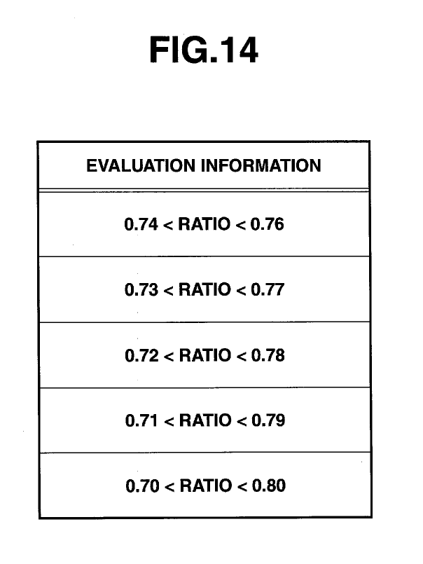

Here, the evaluation information is explained with reference to FIG. 14. FIG. 14 is a diagram showing a table in which the evaluation information is stored. The evaluation information in the present embodiment refers to information having ranges of ratios of the first time and the second time in cases of an ideal golf swing being made.

Specifically, it is found that the most ideal ratio among the ratios is 0.75. Therefore, it is determined that an ideal swing is made if the ratio falls into a predetermined range from 0.75. As shown in FIG. 14, a plurality of ranges is stored in the table and the rhythm evaluation unit 52 randomly acquires one range from among the plurality of ranges. Alternatively, the rhythm evaluation unit 52 may acquire the one range in response to a signal of a user's instructional operation received from the input unit 17.

The rhythm evaluation unit 52 determines that an ideal swing was made in a case in which the ratio falls into the one range selected. Furthermore, in a case in which the ratio substantially matches 0.75, it is determined that the most ideal swing was made.

It should be noted that, although five ranges are exemplified in FIG. 14, the present invention is not limited thereto, and a variety of ranges may be set so long as the ratio still falls into a predetermined range from 0.75.

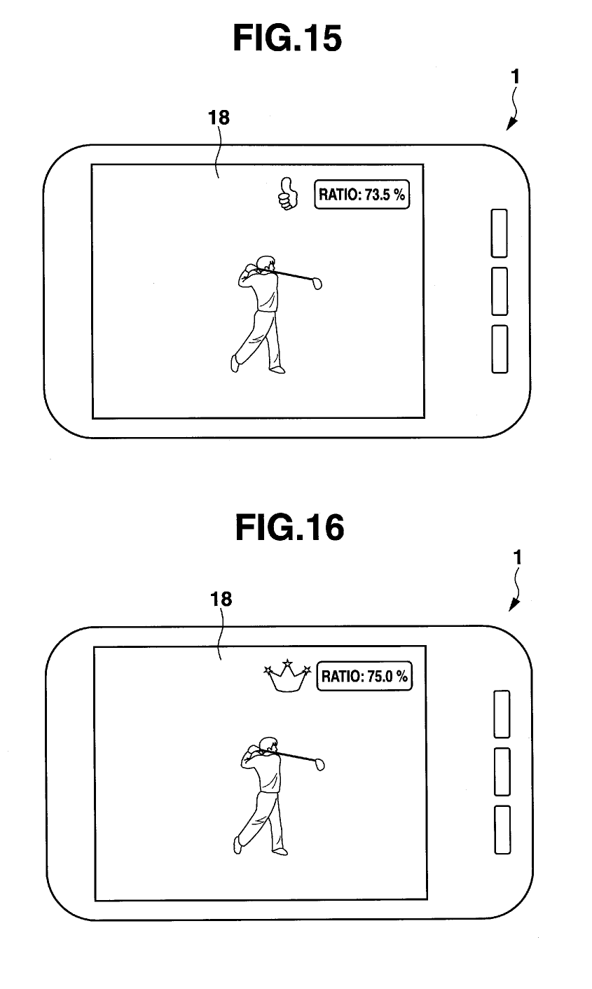

The image generation unit 53 generates a notification image as shown in FIG. 15 in a case in which it is determined by the rhythm evaluation unit 52 that the ratio falls into a range of evaluation information selected and an ideal swing was made. In the notification image shown in FIG. 15, a thumb-up image indicating on the output unit 18 that an ideal swing was made is displayed along with a ratio. This example refers to the example in which “0.72<ratio<0.78” is selected.

Furthermore, the image generation unit 53 generates a notification image as shown in FIG. 16 in a case in which it is determined by the rhythm evaluation unit 52 that the ratio substantially matches 0.75 and the most ideal swing was made. In the notification image shown in FIG. 16, a crown image indicating on the output unit 18 that the most ideal swing was made is displayed along with a ratio.

Furthermore, the image generation unit 53 generates a notification image (not shown) that does not include an image that is associated with a ratio such as the crown image in a case in which it is determined by the rhythm evaluation unit 52 that the ratio does not fall into a range of evaluation information selected by the rhythm evaluation unit 52.

The notification unit 54 notifies to a user a notification image by outputting to display data of the notification image generated by the image generation unit 53 from the output unit 18.

### Evaluation Result Notification Processing

Then, evaluation result notification processing executed by the information generation apparatus 1 is described.

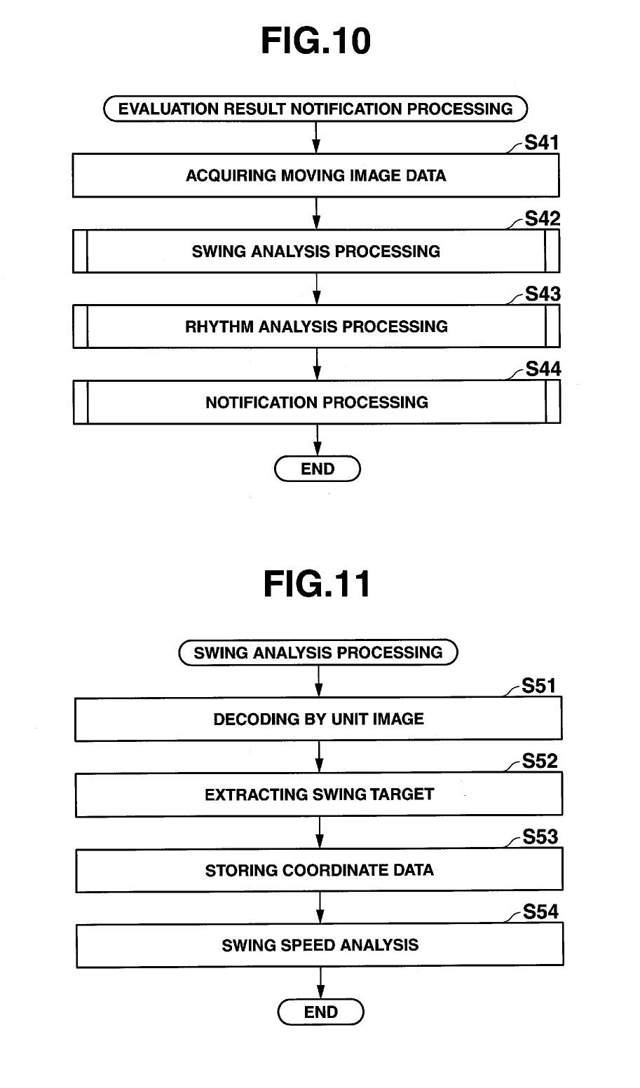

FIG. 10 is a flowchart showing an example of a flow of evaluation result notification processing (main flow) executed by the information generation apparatus 1 of FIG. 1 having the functional configuration of FIG. 9.

In FIG. 10, when data of a moving image of a subject (player) captured consecutively by the image capture unit 16 is outputted, the following processing of Steps S41 to S44 is executed.

The processing of Steps S41 and S42 is similar to Steps S1 and S2 of FIG. 5 of the first embodiment.

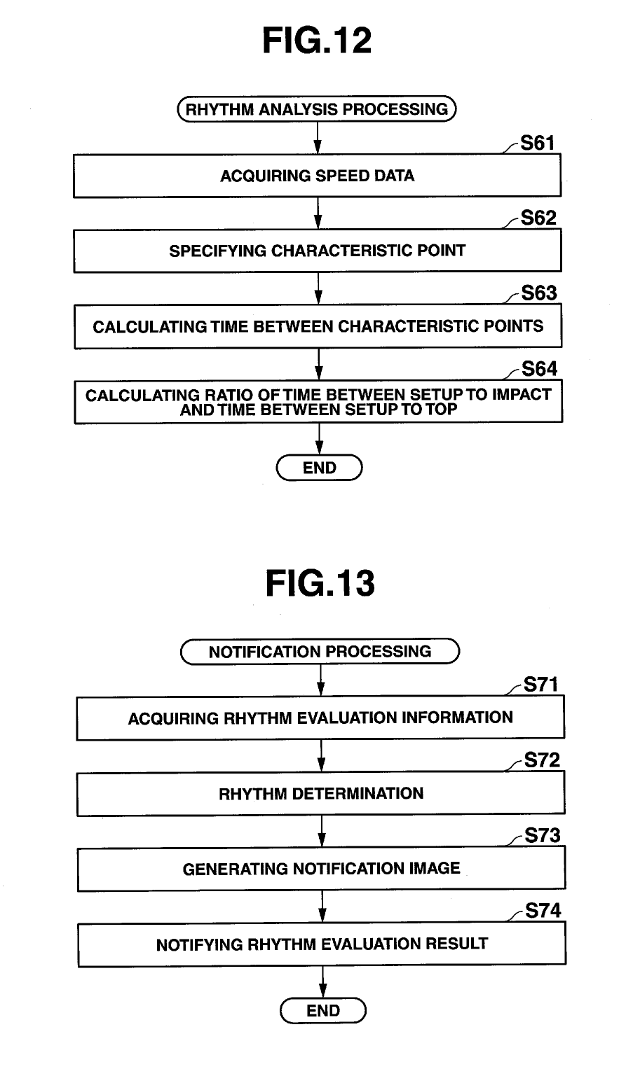

In Step S43, the speed data acquisition unit 44 and the like specify each characteristic point based on swing characteristic data of a professional golfer and a player created by the processing of Step S42 and calculates the ratio of the first time and the second time based on the characteristic point specified. The processing by such a speed data acquisition unit 44 and the like of Step S43 is called “rhythm analysis processing” in accordance with FIG. 10. The details of the rhythm analysis processing are described later with reference to FIG. 12.

Next, in Step S44, the rhythm evaluation unit 52 and the like evaluate the ratio calculated in the processing of Step S43 based on evaluation information; generate a notification image; and output the notification image to the output unit 18. The processing by such a rhythm evaluation unit 52 and the like of Step S44 is called “notification processing” in accordance with FIG. 10. The details of the notification processing are described later with reference to FIG. 14.

When the processing of Step S44 ends, the rhythm evaluation result notification processing ends.

### Swing Analysis Processing

Next, swing analysis processing executed by the information generation apparatus 1 is described.

FIG. 11 is a flowchart showing an example of a flow of swing analysis processing (the processing of Step S42 of FIG. 10) executed by the information generation apparatus 1 of FIG. 1 having the functional configuration of FIG. 9.

The processing of Steps S51 to S54 executed by the swing analysis processing is similar to the processing of Steps S11 to S14 in the swing analysis processing of FIG. 6.

### Rhythm Analysis Processing

Next, rhythm analysis processing executed by the information generation apparatus 1 is described.

FIG. 12 is a flowchart showing an example of a flow of the rhythm analysis processing (the processing of Step S43 of FIG. 10) executed by the information generation apparatus 1 of FIG. 1 having the functional configuration of FIG. 9.

The processing of Steps S61 and S62 is similar to the processing of Steps S21 and S22 in the information generation processing of FIG. 7.

In Step S63, the elapsed time calculation unit 511 included in the rhythm analysis unit 51 calculates an elapsed time between each characteristic point specified in Step S62. More specifically, the time calculation unit 511 calculates the first time by dividing the number of frames of images captured between the setup point in time and the top point in time by the frame rate. The same applies to the second elapsed time as well.

Next, in Step S64, the ratio calculation unit 512 calculates the ratio of the first time and the second time based on the first time and the second time calculated in Step S63. In other words, the ratio is calculated by dividing the first time by the second time.

When the processing of Step S64 ends, the rhythm analysis processing ends.

### Notification Processing

Next, notification processing executed by the information generation apparatus 1 is described.

FIG. 13 is a flowchart showing an example of a flow of notification processing (the processing of Step S44 of FIG. 1) executed by the information generation apparatus 1 of FIG. 1 having the functional configuration of FIG. 9.

In Step S71, the rhythm evaluation unit 52 randomly acquires one range, which is shown in FIG. 14, as evaluation information from the table in which a plurality of pieces of information of the ratios of the first time and the second time are stored. Alternatively, the rhythm evaluation unit 52 may acquire the one range in response to a signal of a user's instructional operation received from the input unit 17.

In Step S72, the rhythm evaluation unit 52 determines whether the ratio falls into the one range acquired in Step S71. In a case in which the ratio falls into the one range, the rhythm evaluation unit 52 determines that an ideal swing was made. Furthermore, in a case in which the ratio substantially matches 0.75, it is determined that the most ideal swing was made.

In Step 73, the image generation unit 53 generates a notification image as shown in FIG. 15 in a case in which it is determined that the ratio falls into a range of evaluation information selected and an ideal swing was made in Step S72. Furthermore, in Step S73, the image generation unit 53 generates a notification image as shown in FIG. 16 in a case in which it is determined that the ratio substantially matches 0.75 and the most ideal swing was made in Step S72. In Step S73, the image generation unit 53 generates a notification image (not shown) that does not include an image that is associated with a ratio such as the crown image in a case in which the ratio does not fall into a range of evaluation information selected in Step S72.

In Step S74, the notification unit 54 notifies to a user a notification image by outputting by display the data of the notification image generated in Step S73 from the output unit 18.

When the processing of Step S74 ends, the notification processing ends.

The second embodiment of the present invention is described above.

The information generation apparatus 1 executing such rhythm evaluation result notification processing as described above includes the characteristic point specification unit 45 and the image generation unit 53.

The characteristic point specification unit 45 specifies a predetermined point in time of a motion in a sequence of motions of a subject.

The image generation unit 53 generates a notification image relating to the sequence of motions based on the predetermined point in time of a motion specified by the characteristic point specification unit 45.

Therefore, such an information generation apparatus 1 can generate a notification image in response to the sequence of motions based on the predetermined point in time of the motion specified by efficiently employing swing analysis data relating to a sequence of motions of a subject.

The information generation apparatus 1 further includes the notification unit 54.

The image generation unit 53 generates a notification image that evaluates the sequence of a motion of a golf swing as information relating to a sequence of motions of a golf swing.

The notification unit 54 outputs by displaying on the output unit 18 the notification image generated by the image generation unit 53.

Therefore, such an information generation apparatus 1 can generate a notification image that evaluates the sequence of motions of a golf swing based on the predetermined points in time of motions specified (the setup point in time, the top point in time, and the impact point in time) by effectively employing swing analysis data relating to a sequence of motions of a golf swing of a subject.

The information generation apparatus 1 further includes: the evaluation information storage unit 64, the rhythm analysis unit 51, and the rhythm evaluation unit 52.

The characteristic point specification unit 45 specifies a plurality of predetermined points in time of motions (the setup point in time, the top point in time, and the impact point in time).

The evaluation information storage unit 64 stores a plurality of pieces of information evaluating the sequence of motions of a golf swing.

The rhythm analysis unit 51 analyzes a rhythm of the sequence of motions of a golf swing based on the plurality of predetermined points in time of motions specified by the characteristic point specification unit 45. In other words, the rhythm analysis unit 51 calculates the ratio of the time between the setup point in time and the top point in time and the time between the setup point in time and the impact point in time.

The rhythm evaluation unit 52 selects a specific piece of evaluation information from a plurality of pieces of evaluation information stored in the evaluation information storage unit 64, based on the ratio that is an analysis result by the rhythm analysis unit 51.

The image generation unit 53 generates a notification image that evaluates the sequence of motions of a golf swing based on the specific information selected by the rhythm evaluation unit 52.

Therefore, such an information generation apparatus 1 can generate a notification image according to the sequence of motions of a golf swing based on the ratio of the time between the setup point in time and the top point in time, and the setup point in time and the impact point in time, and the information that evaluates the sequence of motions of a golf swing.

Therefore, it is possible for a user to know whether an ideal golf swing was made or not.

The information generation apparatus 1 further includes the image acquisition unit 42.

The image acquisition unit 42 acquires a plurality of images in which a sequence of motions of a subject is captured.

The characteristic point specification unit 45 specifies a predetermined point in time of a motion in the sequence of motions in a plurality of images acquired by the image acquisition unit 42.

Therefore, it is possible to effectively employ data of a sequence of motions of a subject.

It should be noted that the present invention is not to be limited to the aforementioned embodiment, and that modifications, improvements, etc. within a scope that can achieve the object of the present invention are also included in the present invention.

For example, the information generation apparatus 1 may generate and output by displaying information as to to which motion of a golf swing a characteristic point specified corresponds (information that notifies that the characteristic point specified corresponds to the top) and information between characteristic points specified (information of a time between the top and the impact, and the like).

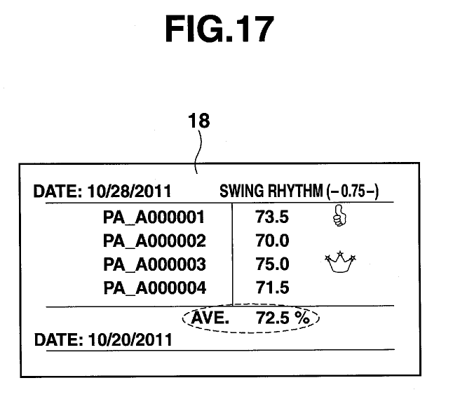

Furthermore, for example, it may be configured so that the information generation apparatus 1 stores a plurality of the ratios of the first time and the second time for each photographing date and time in the storage unit 19, generates a notification image (refer to FIG. 17) including an image with an average value of the plurality of ratios, and outputs the notification image generated to the output unit 18.

Furthermore, although the cases of applying the present invention are described with the data of a moving image in which the swing of a golf club is photographed as a target in the abovementioned first and second embodiments, for example, the present invention can be applied for comparison of various motions. For example, the present invention can be applied for comparison of motions such as the swing of a baseball bat, the swing of a tennis racket, choreography, and the like.

In the aforementioned first and second embodiments, a digital camera has been described as an example of the information generation apparatus 1 to which the present invention is applied; however, the present invention is not particularly limited thereto.

For example, the present invention can be applied to any electronic device in general having an image processing function. More specifically, for example, the present invention can be applied to a lap-top personal computer, a printer, a television, a video camera, a portable navigation device, a cell phone device, a portable gaming device, and the like.

The processing sequence described above can be executed by hardware, and can also be executed by software.

In other words, the hardware configuration shown in FIG. 2 or FIG. 9 is merely an illustrative example, and the present invention is not particularly limited thereto. More specifically, the types of functional blocks employed to realize the above-described functions are not particularly limited to the example shown in FIG. 2 and FIG. 9, so long as the information generation apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray Disk, or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 19 shown in FIG. 1 or the like, in which the program is recorded.

It should be noted that, in the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely exemplification, and do not limit the technical scope of the present invention. Other various embodiments can be employed for the present invention, and various modifications such as omission and replacement are possible without departing from the sprits of the present invention. Such embodiments and modifications are included in the scope of the invention and the summary described in the present specification, and are included in the invention recited in the claims as well as the

1. An information generation apparatus comprising:
a specification unit that specifies a plurality of points in time of a sequence of motions of a person; and
a generation unit that generates information relating to a rhythm of the sequence of motions, based on the plurality of points in time specified.

2. The information generation apparatus according to claim 1, further comprising:
a replay unit that synchronizes, with the information relating to the rhythm generated, and plays a plurality of images in which the sequence of motions of the person is captured.

3. The information generation apparatus according to claim 1,
wherein the generation unit generates information for evaluating the sequence of motions as information relating to the rhythm of the sequence of motions,
the information generation apparatus further comprising: a display control unit that displays the information generated by the generation unit on a display unit.

4. The information generation apparatus according to claim 3,
wherein the specification unit specifies the plurality of points in time,
the information generation apparatus further comprising:
a storage unit that stores a plurality of information for evaluating the sequence of motions;
an analysis unit that analyzes the rhythm of the sequence of motions based on the plurality of points in time specified; and
a selection unit that selects a specific piece of evaluation information from a plurality of pieces of evaluation information stored in the storage unit based on an analysis result by the analysis unit,
wherein the generation unit generates information for evaluating the sequence of motions based on the specific information selected.

5. The information generation apparatus according to claim 1, further comprising:
an acquisition unit that acquires a plurality of images in which the sequence of motions of the person is captured,
wherein the specification unit specifies a point in time of the sequence of motions in the plurality of images acquired.

6. An information generation method executed by an information generation apparatus, comprising:
a specification step of specifying a plurality of points in time of a sequence of motions of a person; and
a generation step of generating information relating to a rhythm of the sequence of motions, based on the plurality of points in time specified.

7. A storage medium encoded with a computer-readable program that enables a computer to execute functions as:
a specification unit that specifies a plurality of points in time of a sequence of motions of a person; and
a generation unit that generates information relating to a rhythm of the sequence of motions, based on the plurality of points in time specified.

8. The information generation apparatus according to claim 2, further comprising:
an acquisition unit that acquires a plurality of images in which the sequence of motions of the person is captured,
wherein the specification unit specifies a point in time of the sequence of motions in the plurality of images acquired.

9. The information generation apparatus according to claim 3, further comprising:
an acquisition unit that acquires a plurality of images in which the sequence of motions of the person is captured,
wherein the specification unit specifies a point in time of the sequence of motions in the plurality of images acquired.

10. The information generation apparatus according to claim 4, further comprising:
an acquisition unit that acquires a plurality of images in which the sequence of motions of the person is captured,
wherein the specification unit specifies a point in time of the sequence of motions in the plurality of images acquired.
